(19) United States
(12) Patent Application Publication
(10) Pub. No.: US 2020/0167404 A1
(43) Pub. Date: May 28, 2020

(54) Computer-Implemented Method and System for Synthesizing, Converting, or Analysing Shapes

(71) Applicant: Genicap Beheer B.V., Tilburg (NL)

(72) Inventor: Johan Leo Alfons Gielis, Antwerpen (BE)

(21) Appl. No.: 16/618,529

(22) PCT Filed: Jun. 1, 2018
(86) PCT No.: PCT/NL2018/050358

§ 371 Date: Dec. 2, 2019

(30) Foreign Application Priority Data
Jun. 1, 2017 (NL) 2019012

(51) Int. Cl. G06F 17/11; G06T 7/60; G06T 19/20

(52) U.S. Cl. CPC G06F 17/11; G06T 2219/2021; G06T 19/20; G06T 7/60

(57) ABSTRACT

The invention relates to a computer-implemented method for synthesizing, optimizing, converting and/or analysing shapes, in particular natural shapes. The invention also relates to a system configured to execute at least one computer-implemented method according to the invention.

The invention relates to a computer-implemented method for synthesizing, optimizing, converting and/or analysing shapes, in particular natural shapes. The invention also relates to a system configured to execute at least one computer-implemented method according to the invention.

One of the major motivations in science is the geometrical description of shape, form, or phenomena, as a step towards understanding natural phenomena in a kinematic or dynamic way. From such scientific descriptions, technology can be derived, for example Newton's laws and the laws of quantum physics. The vast majority of such laws are based on isotropic directions, with the circle and straight line as basic shapes. This is the result of mathematical abstraction and scientific idealisations, resulting initially in Euclidean geometry, later in extension and generalizations. In nature however, a wide variety of shapes can be observed that are not circular at all. They may be symmetrical like starfish or flowers, but can also be asymmetrical, for example zygomorphous flowers. In many cases the symmetry cannot be discovered at all, as in chaotic fluid dynamics or Brownian motion, and only statistical methods can be used to model such phenomena.

In order to make all natural shapes commensurate a common ruler or method of measuring needs to be developed. In 1818 Gabriel Lamé generalized the circle to include square and rectangles, rhombs and supercircles, and spheres into cubes and beams, ellipsoids and ovaloids, all captured into one single equation. Lamé curves and surfaces were generalized to any symmetry, as the Superformula describing Gielis curves, surfaces and (sub)manifolds for any dimension, also known as Gielis transformations. Here, reference is e.g. made to U.S. Pat. No. 7,620,527. The Superformula describes abstract shapes as different as triangles, polygons, prisms and cubes and natural shapes like diatoms, starfish, flowers and molluscs. The names Superformula and supershapes originate from the original connection to supercircles, superellipses and superquadrics, another name for Lamé curves and surfaces.

Despite its wide and pervasive use, the Superformula uses transcendental functions (sine and cosine) that need to be computed via power series inside a computing device. This restricts the use of the Superformula, in all domains where special functions and polynomials are used, which includes all of approximation theory and computational mathematics, and the manifold applications in high performance computing in science and technology, including operations research, simulation of operations, statistical modelling and applications, modern radar techniques/SAR imaging, satellite remote sensing, coding, and robotic systems. In particular, the development of the known Superformula a conversion of Cartesian into polar coordinates was necessary, and the inverse conversion, from polar Equation 1 into Cartesian coordinates with algebraic functions of 1 or more variables was deemed impossible.

It is an object of the invention to provide an improved mathematical method for synthesizing, analysing, optimizing, and/or converting shapes.

To this end, the invention provides different methods and systems according to the appended claims.

More in particular, the abovementioned reverse step is developed, namely to express such shapes in Cartesian coordinates, to convert the transcendental functions into algebraic functions of one or more variables. This can be achieved using Chebyshev polynomials T and U. These originate from the work of the Russian mathematician Pafnuty Chebyshev in the mid 19^{th} century, who laid the foundation for orthogonal polynomials with extremely wide applications in applied mathematics and physics. There is hardly any field in physics and technology where these special functions are not used. Considering Tₘ(cosϑ)=cos mϑ and using cosϑ=x the Superformula can be rewritten as follows:

$$ϱ ( x ) = \frac{1}{\sqrt[{n}_{1}]{{\vert \frac{1}{a} {T}_{m} ( x ) \vert}^{{n}_{2 }} + {\vert \frac{1}{b} \sqrt{1 - {x}^{2}} {U}_{m - 1} ( x ) \vert}^{{n}_{3}}}} \qquad ( Equation 1 )$$

for −1≤x≤+1. The substitution for Gielis curves is

$$x = cos \frac{ϑ}{4} .$$

For Lamé curves a=b=1, n₁=n₂=n₃=n, and m=1 so we have Tₘ=T₁ and Uₘ₋₁=U₁. This gives a algebraic polynomial function of transcendental arguments. In a further step also the exponents can be internalized in the Chebyshev polynomials so that we have real polynomials, which can be calculated using the recurrence relations for Chebyshev polynomials. The roots of the polynomials correspond to the maxima and minima of the Superformula. Each Chebyshev polynomial is composed of a finite number of terms. For example T₀(x)=1, T₁(x)=x, T₂(x)=2x²−1, T₃(x)=4x³−3x, T₄(x)=8x⁴−8x²+1, etc. Tₙ contains terms in x of the powers n, (n−2), (n−4), . . . ending in −1 or +1 for even powers xⁿn, and in +/−nx for odd n. The expression in polar coordinates can then be studied in variable x. In this way it can be shown that for suitable choice of parameters (exponents n and symmetry parameter m are integers) the Superformula can be regarded as a algebraic function.

This inverse transformation is based on the obvious but novel observation that Grandi curves ( [symbol] (ϑ)=cos mϑ) simply are Chebyshev polynomials of the first kind Tₘ(cosϑ)=cos mϑ. ( [symbol] (ϑ)=sinϑ is related to the Chebyshev polynomial of the second kind

$${U}_{m} ( x ) = \frac{sin ( m + 1 ) ϑ}{sin m ϑ}$$

for m integer.

Chebyshev polynomials can be generalized, both Tₘ and Uₘ

$$\begin{matrix}ϱ ( x ) = \frac{{\vert {T}_{m} ( x ) \vert}^{{n}_{4}}}{\sqrt[{n}_{1}]{{\vert {T}_{m} ( x ) \vert}^{{n}_{1}} + {\vert \sqrt{1 - {x}^{2}} {U}_{m - 1} ( x ) \vert}^{{n}_{2}}}} & ( Equation 2 ) \\ ϱ ( x ) = \frac{{\vert {U}_{m} ( x ) \vert}^{{n}_{4}}}{\sqrt[{n}_{1}]{{\vert {T}_{m} ( x ) \vert}^{{n}_{1}} + {\vert \sqrt{1 - {x}^{2}} {U}_{m - 1} ( x ) \vert}^{{n}_{2}}}} & ( Equation 3 )\end{matrix}$$

This can straightforwardly generalized for multivariate and multi-argument Chebyshev polynomials.

Hence, generalized forms of the Superformula are used as arguments in Chebyshev polynomials. The classical transformation in Chebyshev is

$$x = cos ϑ or x = cos \frac{ϑ}{4} .$$

The argument of the cosine can be any function (see FIG. 1). In this step of the invention, transformations x=cos(ƒ(ϑ)) can be used. For example,

$$f ( ϑ ) = \vert 3 ( ϑ - \frac{π}{2} ) \vert or f ( ϑ ) = 3 {cos [ 2 ( ϑ + π ) ]}^{2} .$$

Chebyshev polynomials are finite and precise, and are known to give best possible approximation to functions. Power laws, ubiquitous in the natural sciences, can be defined accurately in terms of Chebyshev polynomials. Another example in shape description related to rational approximations of shape descriptors in botany based on elliptic Fourier series: for even functions (for example the mirror symmetry of a leaf around the midrib) the Fourier series can be rewritten in terms of Chebyshev polynomials. Chebyshev polynomials are central in mathematics with many links to other groups of polynomials. For example, there is the direct relation of Chebyshev polynomials to the widely used Lucas Lₙ and Fibonacci Fₙ numbers and polynomials. They can all be considered as special cases of the homogeneous linear second order difference equation with constant coefficients u₀; u₁; uₙ₊₁=auₙ+buₙ₋₁, for n≤1. If a and b are polynomials in x, a sequence of polynomials is generated. In particular if a=2x and b=−1, we obtain Chebyshev polynomials. They are of the first kind Tₙ (x) for u₀=1; u₁=x, and of the second kind Uₙ (x) for u₀=1; u₁=2x. Fibonacci numbers Fₙ, arise for a=b=1; u₀=0; u₁=1. For a=b=1; u₀=2; u₁=1, we obtain Lucas numbers Lₙ. Therefore, if in Chebyshev polynomials i=\sqrt{−1} is used with

$$x = \frac{i}{2}$$

the results are Lucas numbers Lₙ for Chebyshev polynomials of the first kind Tₙ, and Fibonacci numbers Fₙ for those of the second kind Uₙ. This is not limited to the first or second Chebyshev polynomials, but also Chebyshev polynomials of, for example, the third and fourth kind can be used. In addition, this invention can include generalized version of the multivariable case. This opens the field of applications of the modified Superformula as incorporated in the appended claims (also referred to as Chebyshev-Gielis Transformations) in all domains where polynomials and special polynomials are used, which includes all of approximation theory and computational mathematics, operations research, statistical modelling and applications, and physics. Making use of recurrence formulae of the Chebyshev polynomials, the modified Superformula can now be based on algebraic functions greatly expanding the trigonometric functions. Real analysts use Fourier series, complex analysts use Laurent series, and numerical analysts use Chebyshev. The mathematics of the connections between the three frameworks provides a significant number of new possibilities. In this patent document the step from the Superformula to numerical analysis is made and disclosed. Nevertheless, the Superformula is Pythagorean compact (i.e. Pythagorean Theorem is special case for exponents equal 2), and thus much more compact than Fourier or Laurent series. The present invention constitutes the generalization of Chebyshev polynomials into Pythagorean compact representations, which provides a great advantage.

The current invention can be applied in various and more technical fields (compared to the conventional Superformula), such as, for example, digital filter and circuit design, computations in computers, processing seismic signals, data analysis and compression, the design of lenses, turbines, spiral polynomial division multiplexing, asymmetrical Chaotic Encryption, attitude and orbit arm integrated motion planning method used for rapidly capturing on orbit, harmonic encoding for FWI, gas turbine engine, ISAR imaging method based on matching tracking, dynamic gesture learning and identifying method based on Chebyshev neural network, simple support beam damage and moving force simultaneous identification method under moving load, three-dimensional seismic data waveform semi-supervised clustering method based on EM algorithm, method for constructing light gauge welding residual stress field on basis of small-hole process tested data, 2D seismic data all-horizon automatic tracking method based on unsupervised classification, generalized Chebyshev filter integrated design method based on conformal transformation, direct integrated design method for random-bandwidth multi-pass-band generalized Chebyshev filter, bounding a metric for data mining on compressed data vectors, Chebyshev output method for space motion state of rigid body, computations of power functions using polynomial approximations, methods for designing a lens surface, and lenses designed by the same, method of calculating line spectral frequencies, noise corrected pole and zero analysis, data compression, modelling handwriting using polynomials as a function of time, production of sinusoidal/cosinusoidal oscillations, improving aerial image simulation speeds, extraction for real-time pattern recognition using single curve per pattern analysis, fast IEEE double precision reciprocals and square roots, multiplying frequencies, digital forecast filters, pole zero measuring instrument of transfer function, determination of line spectrum frequencies for use in a radiotelephone, digital tone detection and generation, illuminant distribution evaluating method, illumination optics, exposure apparatus, processing seismic data signals, vision technologies, optimization of radiofrequency components and metamaterials, artificial intelligence and neural networks, robotics, medical imaging and the development of medical devices (such as sensors, stents . . . ), product design and developments, computer graphics and game technology, radio communication, new forms of energy via nuclear fusion, quantum computing and the development of analogue computers.

Chebyshev polynomials are a set of orthogonal functions, each function being independent of all other functions. Surfaces made up of discrete points, rather than equations, may be represented using piece-wise Chebyshev polynomials of a suitable order and in any direction, or using Chebyshev polynomials to fit each of a number of sections of the surface. For example, one section of a surface may be fitted using a Chebyshev polynomial and then the range of the fit is shifted and another section is fitted, rather than fitting a single function to the entire data set for the surface. Any of a number of methods may be used to determine the order of the Chebyshev polynomial to be used. For example, the fit may approximate the surface shape to a selected tolerance, may be arbitrarily selected, or may be of a simple relationship, such as the order of fit equalling the number of points+1. Generally, a rapidly varying surface shape will require a higher order fit than a smoothly changing surface. Preferably, a third order polynomial is used.

The surface of a product may be divided into any number of desired sections. The number of sections, or zones used, may be determined based on the order of the fitting polynomial and the number of discrete points used in the surface description. Subsequently, the geometry of each section is defined in terms of a Chebyshev polynomial. The original surface may be divided into 2- or 3-dimensional sections based on the type of surface to be approximated and the manufacturing method to be used. A Chebyshev polynomial is fitted to each of the sections to determine the coefficients used for approximating the original surface shape in the section. These coefficients may be computed by using one of the methods defined in the appended claims. The coefficients may be stored for later use or used directly for interpolating new data points in the section. In interpolating new points, preferably the points are only interpolated from the central portion of each section. For example, in a four point fit, or a fit performed using four points in the section, new data points are interpolated from between points 2 and 3. However, new data points may be interpolated from any portion of the section if required, such as the beginning and end of the data sets when the fit region cannot be shifted. The beginning and end of the local fit section is shifted and another fit is performed. The amount of shift for a section is typically 1 point thus providing 3 overlapping points for adjacent 4 point fit sections. However, the overlapping may be altered from 1 point to n-1 points to provide a 1, 2, or 3 point overlap for a 4 point fit section. The ability to change the order of the Chebyshev fit used for each section of the surface, along with the amount of overlap for adjacent fits and the portion of the fit section from which new points are estimated make the method of the invention an extremely flexible method of approximating the original surface shape. Additionally, the method of the invention provides decreased errors in approximation of the lens surface.

### VARIOUS EMBODIMENTS

In a first embodiment all technologies and applications of Gielis curves, surfaces and (sub)manifolds for any dimension, also known as Gielis transformations, as described above can make use of the present invention.

Since Fourier series can be directly rewritten in terms of Chebyshev polynomials, this also relates to generalized Fourier series (sums of supershapes):

$$ρ ( θ ) = {ρ}_{0} {a}_{0} + {\sum }_{k = 1}^{∞} ( {a}_{k} {ρ}_{k} cos \frac{ {m}_{k} θ}{4} + {b}_{k} {ρ}_{k} sin \frac{ {m}_{k} θ}{4} ) \qquad ( Equation 4 )$$

This can be applied to all methods using Chebyshev polynomials in gas turbine optimization, lens design, printing technologies and so forth. It also relates to all computations on Gielis curves, surfaces and (sub)manifolds for any dimension such as area (or n-area), volume (or n-volume), moments, or derivatives of certain order, on single or compositions of Gielis curves, surfaces and (sub)manifolds, such as via R-functions.

In a second embodiment, using the second step of the invention, square waves are described in one single step. For n₁, n₂ and n₃=1 and for a very large, the first term

$${\vert \frac{1}{a} {T}_{m} ( x ) \vert}^{{n}_{2}}$$

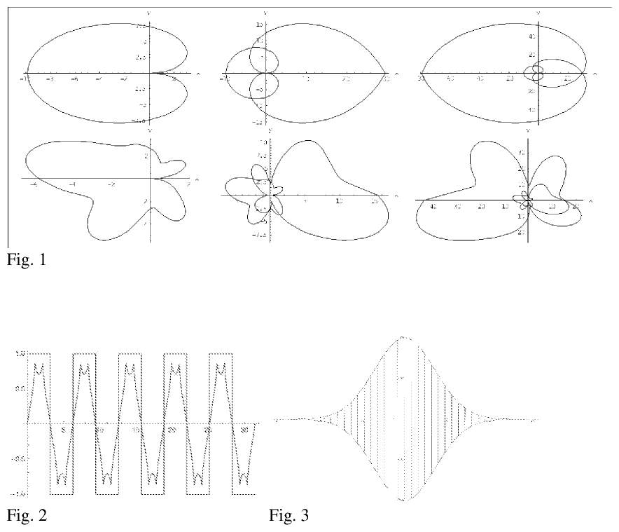

becomes very small and a square wave is obtained. The first term does not disappear guaranteeing differentiability. In this embodiment, a square wave can be encoded directly into one term (FIG. 2 (square and spiked waves)). Such square wave can further also be used in a wavelet-form (FIG. 3 (square wave in Gaussian frame)). In all of mathematics and numerical analysis the use of Fourier series and summations of classic Chebyshev polynomials, to describe waves with certain discontinuities, always result in the Gibbs phenomenon. In this invention, this is completely avoided.

$$ϱ ( x ) = \frac{{U}_{m - 1} ( x )}{\sqrt[{n}_{1}]{{\vert \frac{1}{a} {T}_{m} ( x ) \vert}^{{n}_{2}} + {\vert \frac{1}{b} \sqrt{1 - {x}^{2}} {U}_{m - 1} ( x ) \vert}^{{n}_{3}}}} \qquad ( Equation 5 )$$

Equation 5 can also be written in classical Gielis curves, but in this specific embodiment this is combined with highly efficient computational methods. Various of such supershaped waves, encoded in one term, can form a series by summing these individual waves, into a message and/or a signal. Alternatively, sharp signals with many discontinuities, such as the Weierstrass function, may be modulated with the invention in order to ensure differentiability up to any desired order. Various existing technologies for composing signals and message and their transmission can be greatly improved. In particular methods and circuits arrangement for producing (co)sinusoidal oscillations or multiplexing frequencies.

The modified Superformula, as incorporated in the appended claims, can be used in datamining to solve the problem of irregular domains in datasets by using metrics defined by the modified Superformula. With the present invention, these domains can easily be deconstructed and reconstructed using the Chebyshev and generalized Chebyshev nodes. In addition, the recurrence formulae of Chebyshev polynomials Tₙₘ(x)=Tₙ(Tₘ(x)) and Tₙ₊ₘ(x)=Tₙ(x)Tₘ(x)−Tₙ₋ₘ(x) can be used to reduce the burden in data mining caused by the curse of dimensionality.

In Method and system for analyzing storing and regenerating information (see e.g. WO2014NL50790) the conventional Superformula is used to store and process information and data. The current invention provides, in addition, the necessary computational tools for optimal use of this patent for data processing, storage and used of such data in databases, in path planning in robotics and other application set forth in WO2014NL50790. The present invention can be used to classify, store and retrieve data on shapes and forms of any dimension in a few variables only. In additions, the technique provides for a continuous transformation between shapes and this information, as evolutionary operator between shapes, can be stored and coupled to traceable and retrievable information such as codes, e.g. blockchain.

Another example relates smart data sampling and data reconstruction, such as disclosed in EP2745404. The use of Chebyshev polynomials and nodes, allows for sparse sampling at sub-Nyquist sample rates. From this sparse sampling, the methods set forth in EP2745404 succeed in reconstructing complicated signals of for example Electrocardiograms and electroencephalograms. The combination of these methods with the current invention, allows for a very sparse representation of complex signals.

Another example relates to the use in procedural generation in games and computer technology. In this case the methodology of the invention can be used to superpose Chebyshev polynomials over existing noise levels to efficiently and effectively generate new landscapes, mountain, flowers and trees, naturalistic scenery.

The method and system according to the present invention is also suitable to process existing signals (Wi-Fi, LTE, GSM, millimetre waves (MMWs), GHz and THz applications, and communication via optics or sound) using a filter designed using the modified Superformula as incorporated in the appended claims, so that before transmission with the methods set forth here, the signals are compressed and transmission channel capacity increases. This opens new possibilities in developing new methods relating to the mathematical theory of communications.

The choice of the parameter range used in the modified, improved Superformula, as incorporated in the appended claims, can be exactly the same as in the conventional Superformula:

[symbol]

n₂, n₃ can be any real number

n₁ can be any real number except 0

a, b are strictly positive real numbers

n₂, n₃∈ [symbol] ; a, b∈ [symbol] ₀⁺; n₁∈ [symbol] ₀

Regarding the parameter m, note that there may be confusion regarding m in Superformula and m in Chebyshev. The parameter m in Chebyshev is an integer only, namely Tₘ=cos mϑ, with m integer. Now the question is how to pair this with m in the Superformula, since there m can be a real number. This is actually simple, since the integer has moved to T and the non-integer parts has moved to ϑ.
1. Example with rational numbers. Suppose in Superformula m=5/2. Then we have in the Superformula m/4=⅝. But then we use the part ⅛ to the ϑ, and use the substitution

$$x = cos \frac{ϑ}{8}$$

so the integer part for the Chebyshev form is m=5.
2. Example with irrational numbers. Suppose in SF m/4=\sqrt{2}/4 then we multiply numerator and denominator by \sqrt{2} and get 2/4\sqrt{2}. We now integrate the 2 in the Chebyshev m and use transformation

$$x = cos \frac{ϑ}{4 \sqrt{2}}$$

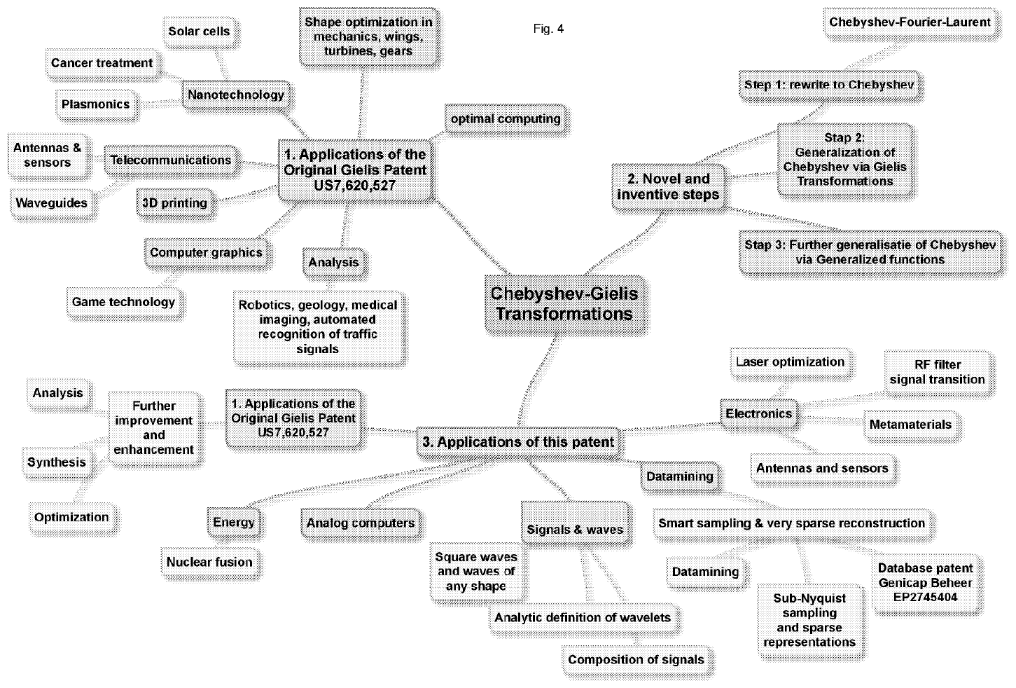

In FIG. 4 an illustrative overview is shown of various processing steps and possible fields of application of the present invention, including improvements with respect to a known computer-implemented, Superformula based method.

It will be apparent that the invention is not limited to the working examples shown and described herein, but that numerous variants are possible within the scope of the attached claims that will be obvious to a person skilled in the art.

The above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application.

The verb “comprise” and conjugations thereof used in this patent publication are understood to mean not only “comprise”, but are also understood to mean the phrases “contain”, “substantially consist of”, “formed by” and conjugations thereof.

1. (canceled)

2. (canceled)

3. A computer graphics display system for computer graphics imaging, comprising:
a processor;
a memory connected to said processor;
a monitor configured to display computer graphic images;
wherein said system is programmed to solve the following equation
$$( x ) = \frac{1}{\sqrt[{n}_{1}]{{\vert \frac{1}{a} {T}_{m} ( x ) \vert}^{{n}_{2}} + {\vert \frac{1}{b} \sqrt{1 - {x}^{2}} {U}_{m - 1} ( x ) \vert}^{{n}_{3}}}}$$
wherein:
n₂, n₃∈ [symbol] ; a, b∈ [symbol] ₀⁺; n₁∈ [symbol] ₀
m∈ [symbol]
−1≤x≤+1
and wherein Tₘ(x) and Uₘ₋₁(x) constitute Chebyshev polynomials, wherein
$${T}_{m} ( x ) = cos m ϑ and {U}_{m - 1} ( x ) = \frac{sin m ϑ}{sin ( m - 1 ) ϑ} ;$$
and
wherein said system is configured to generate a graphic image to be displayed by said monitor, wherein said graphic image is at least partially generated by the processor corresponding to values of ρ based upon used parameter values for parameters a, b, n₁, n₂, n₃, m, x, and ϑ

4. A computer-implemented method for creating naturalistic scenery on an amusement device, the method comprising:
A) generating one or more first images of shapes used in nature using the formula comprising:
$$ϱ ( x ) = \frac{1}{\sqrt[{n}_{1}]{{\vert \frac{1}{a} {T}_{m} ( x ) \vert}^{{n}_{2}} + {\vert \frac{1}{b} \sqrt{1 - {x}^{2}} {U}_{m - 1} ( x ) \vert}^{{n}_{3}}}}$$
wherein:
n₂, n₃∈ [symbol] ; a, b∈ [symbol] ₀⁺; n₁∈ [symbol] ₀
m∈ [symbol]
−1≤x≤+1
and wherein Tₘ(x) and Um₋₁(x) constitute Chebyshev polynomials, wherein
$${T}_{m} ( x ) = cos m ϑ and {U}_{m - 1} ( x ) = \frac{sin m ϑ}{sin ( m - 1 ) ϑ} ;$$
B) creating additional images of shapes used in nature by moderation of formula parameters used to create the one or more first images to create new images with variation in said shapes of said first images; and
C) generating variable naturalistic landscapes by displaying said first images together and creating a preferably time-wise arrangement for display of said additional images.

5. A computer-implemented method for synthesizing square block wave signals, comprising the steps of:
A) Providing a computer toolbox programmed to solve the following equation:
$$ϱ ( x ) = \frac{{U}_{m - 1} ( x )}{\sqrt[{n}_{1}]{{\vert \frac{1}{a} {T}_{m} ( x ) \vert}^{{n}_{2}} + {\vert \frac{1}{b} \sqrt{1 - {x}^{2}} {U}_{m - 1} ( x ) \vert}^{{n}_{3}}}} wherein \text{:}$$
n₁=1; n₂=1; and n₃=1
b∈ [symbol] ₀⁺;
a>100
m∈ [symbol]
−1≤x≤+1.
and wherein Tₘ(x) and Uₘ₋₁(x) constitute Chebyshev polynomials, wherein
$${T}_{m} ( x ) = cos m ϑ and {U}_{m - 1} ( x ) = \frac{sin m ϑ}{sin ( m - 1 ) ϑ} ;$$
and
B) using the computer tool box to synthesize substantially square block wave signals.

6. A computer-implemented method for converting shapes, comprising the steps of:
A) providing a computer toolbox programmed to solve the following first equation:
$$ρ ( ϑ ; f ( ϑ ) , A , B , {m}_{1 , 2} , {n}_{1} , {n}_{2} , {n}_{3} ) = {f ( ϑ ) [ {\vert \frac{1}{A} cos \frac{{m}_{1} ϑ}{4} \vert}^{{n}_{2}} + / - {\vert \frac{1}{B} sin \frac{m \text{?} ϑ}{4} \vert}^{{n}_{2}} ]}^{- \frac{1}{{n}^{3}}}$$
$$\text{?} \text{indicates text missing or illegible when filed}$$
where:
A, B, n₁∈ [symbol] ₀
m₁, m₂, n₂, n₃∈ [symbol]
ϑ∈[0, k2π], where kÅ [symbol]
wherein said tool box is also configured to solve the following second equation:
$$ϱ ( x ) = \frac{{U}_{m - 1} ( x )}{\sqrt[{n}_{1}]{{\vert \frac{1}{a} {T}_{m} ( x ) \vert}^{{n}_{2}} + {\vert \frac{1}{b} \sqrt{1 - {x}^{2}} {U}_{m - 1} ( x ) \vert}^{{n}_{3}}}}$$
wherein:
n₁=1; n₂=1; and n3=1
b∈ [symbol] ₀⁺;
a>100
m∈ [symbol]
−1≤x≤+1
and wherein Tₘ(x) and Uₘ₋₁(x) constitute Chebyshev polynomials, wherein
$${T}_{m} ( x ) = cos m ϑ and {U}_{m - 1} ( x ) = \frac{sin m ϑ}{sin ( m - 1 ) ϑ} ;$$
and
B) using the computer tool box to analyse a first shape generated by using the first equation, such that parameter values corresponding to said shape are determined, and
C) using the computer tool box to synthesize a second shape by using the second equation, and based upon the parameter values determined during step B).

7. (canceled)

8. (canceled)
